(19) United States
(12) Patent Application Publication
(10) Pub. No.: US 2018/0327144 A1
(43) Pub. Date: Nov. 15, 2018

(54) PRODUCE POUCH

(71) Applicant: Sev-Rend Corporation, Collinsville, IL (US)

(72) Inventor: Mark Williams, Lexington, KY (US)

(21) Appl. No.: 15/590,779

(22) Filed: May 9, 2017

(51) Int. Cl. B65D 33/08; B65D 33/06

(52) U.S. Cl. CPC B65D 33/08; B29C 65/02; B65D 33/06; B65D 33/065

(57) ABSTRACT

Disclosed are produce pouches for packaging and transport of heads of produce. Produce pouches according to the present disclosure depart from the conventional concepts and designs of the prior art to provide more efficient and effective packaging and transport of produce, and in particular, produce such as heads of lettuce and cabbage in which it is desirable to keep root balls of the produce intact.

### BACKGROUND

The present disclosure relates food packaging. More particularly, the present disclosure relates to pouches for effective packaging and transport of produce such as heads of lettuce and heads of cabbage having intact root balls.

### BRIEF DESCRIPTION

Bags or pouches are available for packaging fruits, vegetables, and other produce. Pouches are often crafted from an extruded tube of films and mesh materials. Processing steps commonly include hole punching, perforating, and potentially further manufacturing steps designed to produce a specified pouch. Pouches can be vented to help preserve freshness and to permit rinsing.

Some pouches have zipper or slide closures with engaging male and female strips that can be selectively engaged to seal the mouth of the pouch. Other pouches are designed for being tied or fastened in a closed configuration.

Alternative pouches are desirable for packaging and transporting produce. Produce pouches according to the present disclosure depart from the conventional concepts and designs of the prior art to provide more efficient and effective packaging and transport of produce, and in particular, produce such as heads of lettuce and cabbage in which it is desirable to keep root balls of the produce intact.

### BRIEF DESCRIPTION

In one aspect, the present disclosure is directed to a produce pouch comprising a first panel and a second panel joined along a bottom portion and two side edges to form the produce pouch; wherein an upper edge of the produce pouch forms a convex shape; and wherein the bottom portion of the produce pouch is configured to selectively receive a root structure of the produce when introduced to the produce pouch; wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration; wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration.

In another aspect, the present disclosure is directed to a produce pouch comprising a first panel and a second panel joined along a bottom portion and two side edges to form the produce pouch; wherein an upper edge of the produce pouch forms a convex shape; and wherein the bottom portion of the produce pouch is configured to selectively receive a plurality of root structures of the produce when introduced to the produce pouch; wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration; wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration.

### BRIEF DESCRIPTION OF THE DRAWINGS

FIG. 1 is a front elevation view of one embodiment of a PRODUCE POUCH.

FIG. 2 is a rear elevation view thereof.

FIG. 3 is a bottom view thereof.

FIG. 4 is a left side view thereof.

FIG. 5 is a right side view thereof.

FIG. 6 is a top view thereof.

FIG. 7 is a top, front, perspective view thereof.

FIG. 8 is a top, perspective view thereof.

FIG. 9 is a front elevation view of one embodiment of a PRODUCE POUCH.

FIG. 10 is a rear elevation view thereof.

FIG. 11 is a bottom view thereof.

FIG. 12 is a left side view thereof.

FIG. 13 is a right side view thereof.

FIG. 14 is a top view thereof.

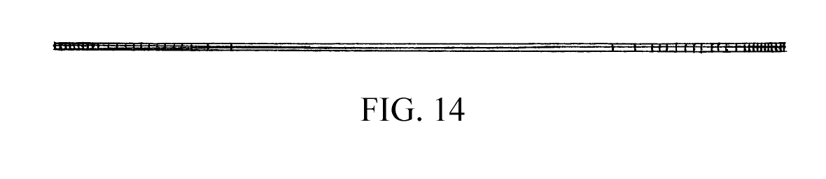

FIG. 15 is a top, front, perspective view thereof.

FIG. 16 is a top, perspective view thereof.

FIG. 17 is a front elevation view of one embodiment of a TWIN PRODUCE POUCH.

FIG. 18 is a rear elevation view thereof.

FIG. 19 is a bottom view thereof.

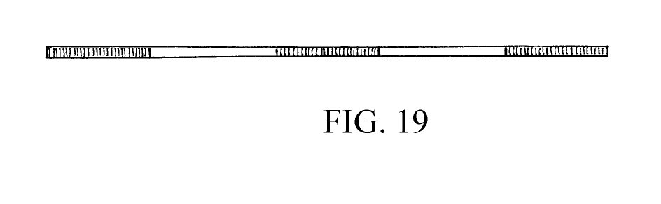

FIG. 20 is a left side view thereof.

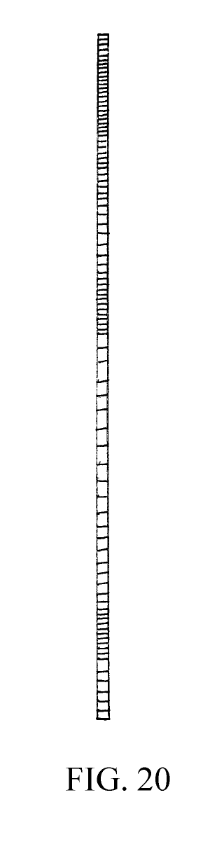

FIG. 21 is a right side view thereof.

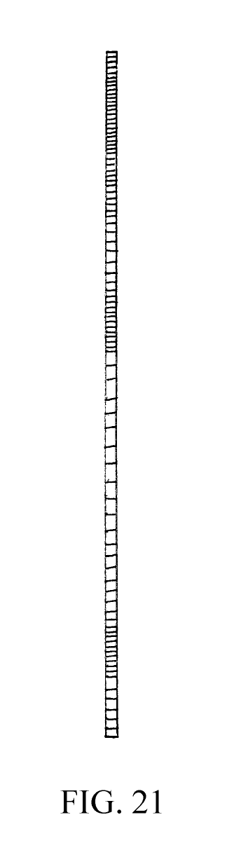

FIG. 22 is a top view thereof.

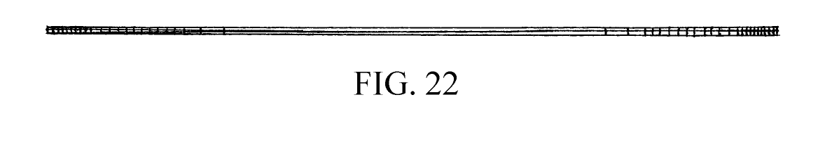

FIG. 23 is a top, front, perspective view thereof.

FIG. 24 is a top, perspective view thereof.

### DETAILED DESCRIPTION

The present disclosure is directed to pouches for effective packaging and transport of produce such as heads of lettuce and heads of cabbage having intact root balls.

In one aspect, the present disclosure is directed to a produce pouch comprising a first panel and a second panel joined along a bottom portion and two side edges to form the produce pouch; wherein an upper edge of the produce pouch forms a convex shape; and wherein the bottom portion of the produce pouch is configured to selectively receive a root structure of the produce when introduced to the produce pouch; wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration; wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration.

In another aspect, the present disclosure is directed to a produce pouch comprising a first panel and a second panel joined along a bottom portion and two side edges to form the produce pouch; wherein an upper edge of the produce pouch forms a convex shape; and wherein the bottom portion of the produce pouch is configured to selectively receive a plurality of root structures of the produce when introduced to the produce pouch; wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration; wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration.

The first panel and the second panel are movable between a closed configuration (wherein the inner surfaces of the panels are directly coupled to each other) and an open configuration (wherein the inner surfaces are separated from each other to define a cavity between the inner surfaces of the first panel and the second panel). During use, an upper edge of first panel is separated from an upper edge of the second panel to define a mouth. The upper edges are pulled away from each other to expand the mouth. A head of produce is inserted into the cavity via the mouth.

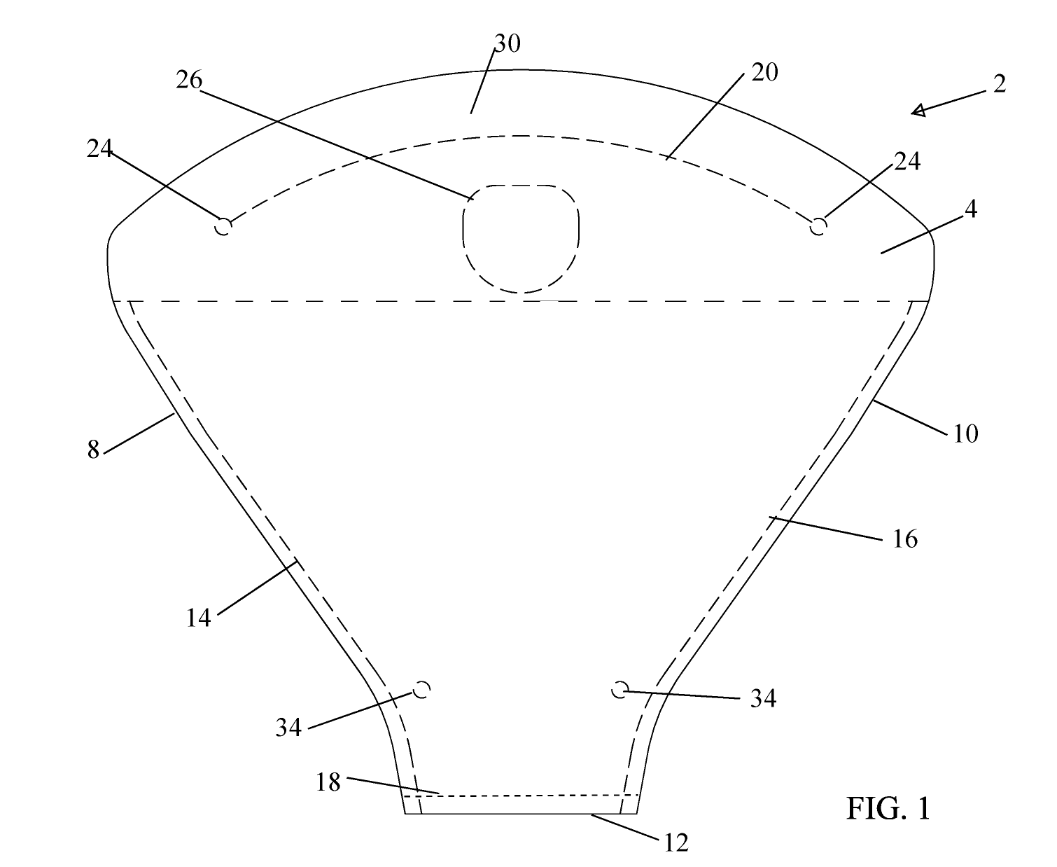

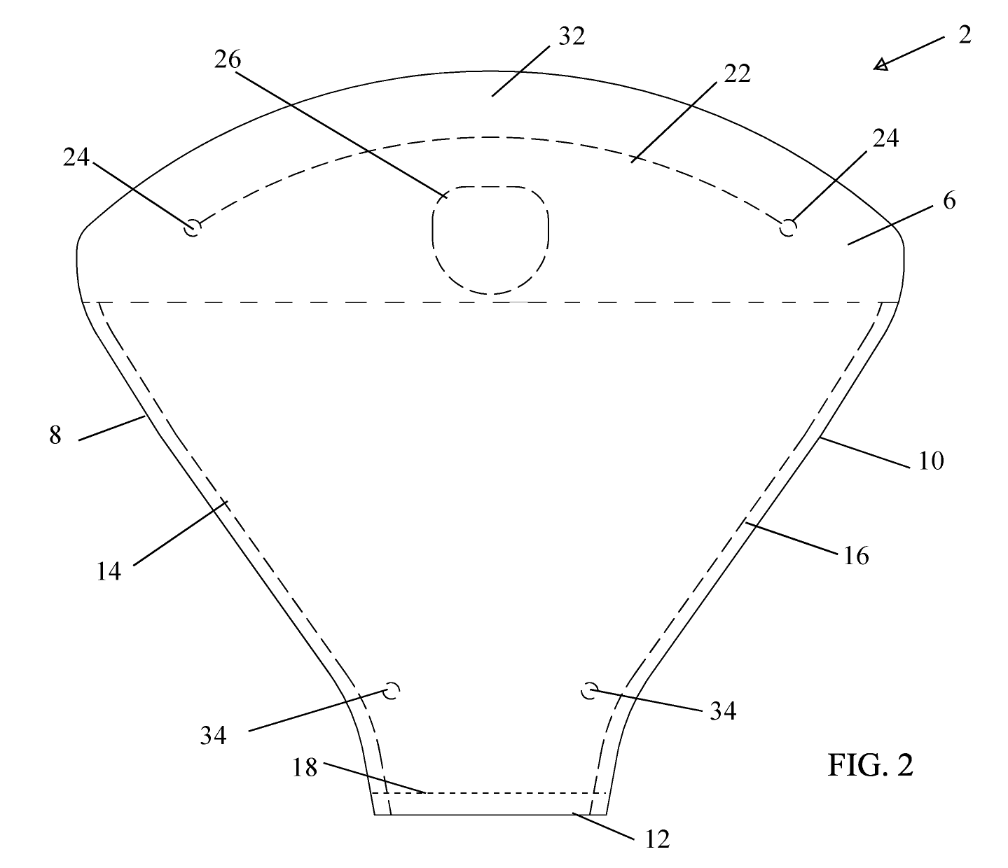

As illustrated in FIGS. 1 and 2, exemplary embodiment of pouch 2 comprises a first (or front) panel 4 and a second (back) panel 6. Left side edges 8, right side edges 10 and lower edges 12 of first panel 4 and second panel 6 are joined using any suitable method known to those skilled in the art to form left side seam 14, right side seam 16, and bottom seam 18. Slit 20 in first panel 4 and slit 22 in second panel 6 end in cut-outs 24. Having slits 20 and 22 end in cut-outs 24 can reduce or prevent tearing of slit ends through material from which pouch is constructed. Hanger cut-outs 26 can optionally be made in first panel 4 and second panel 6 to allow pouch 2 to be hung for display or used with a bag filling machine.

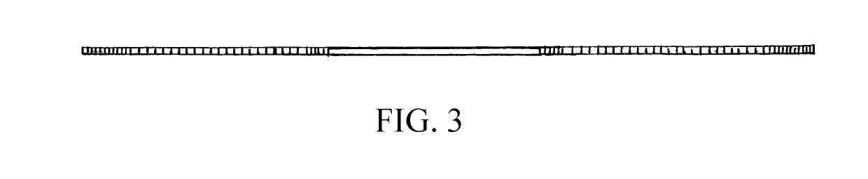

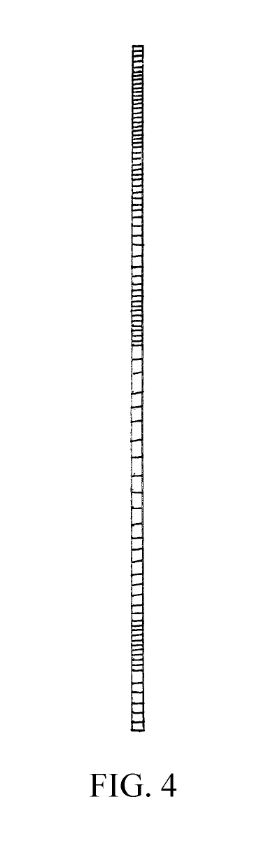

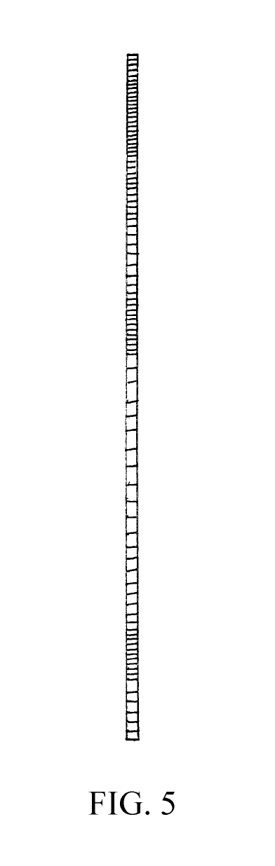

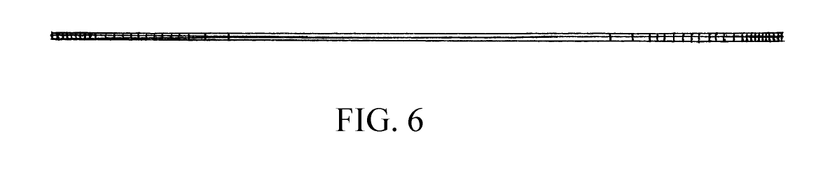

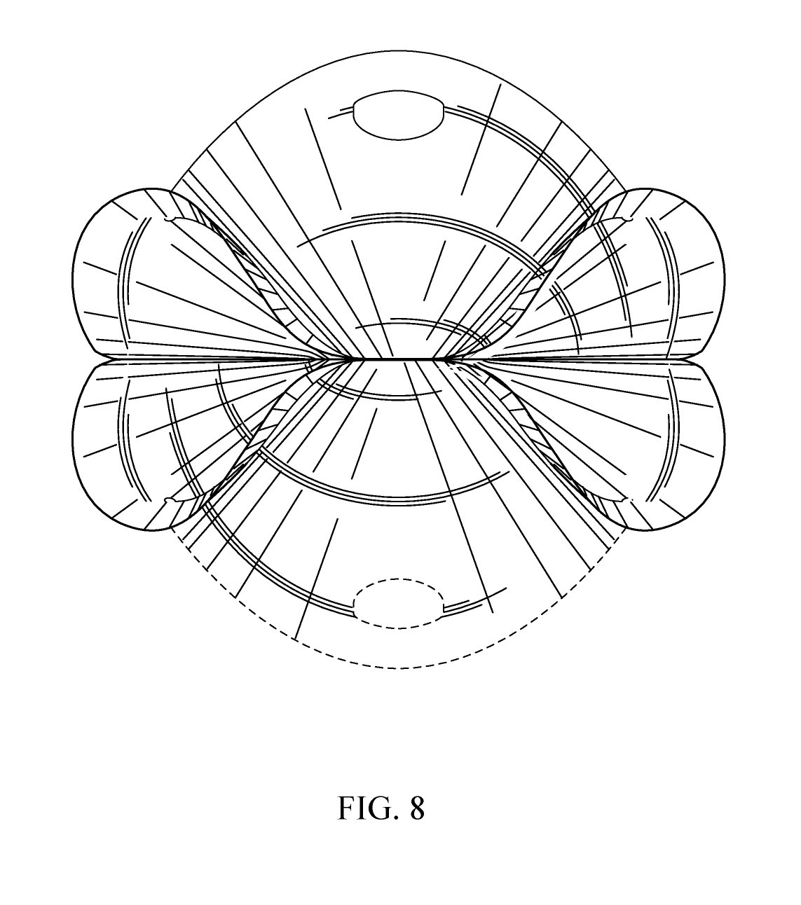

FIGS. 1-8 illustrate an embodiment useful for packaging produce such as Romaine lettuce heads that are more elongated in structure.

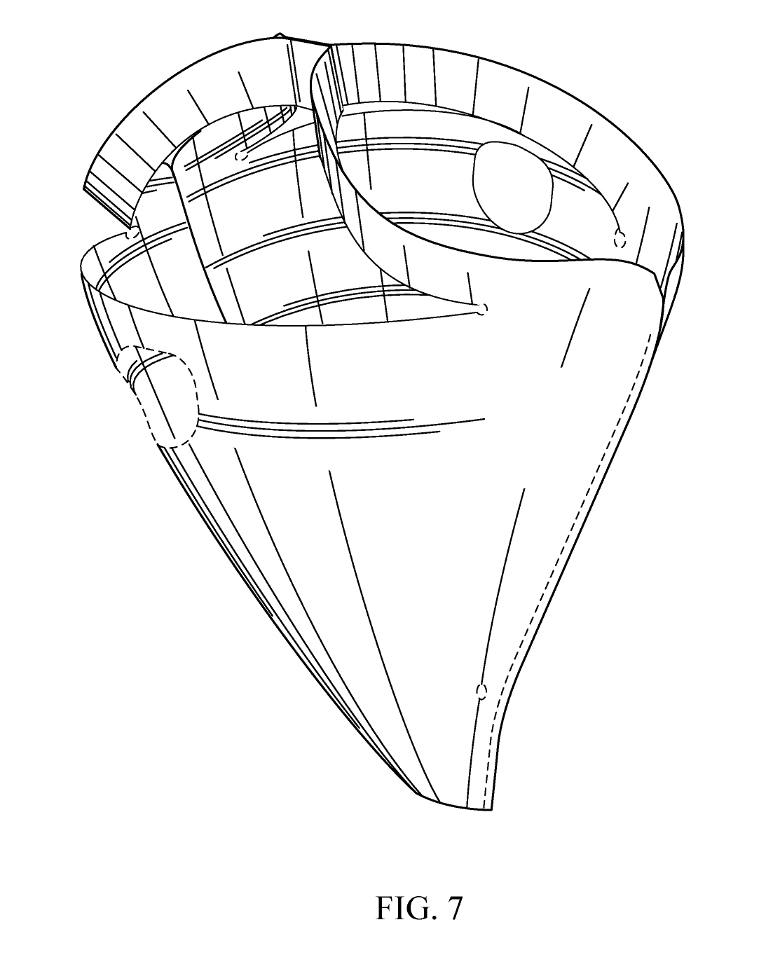

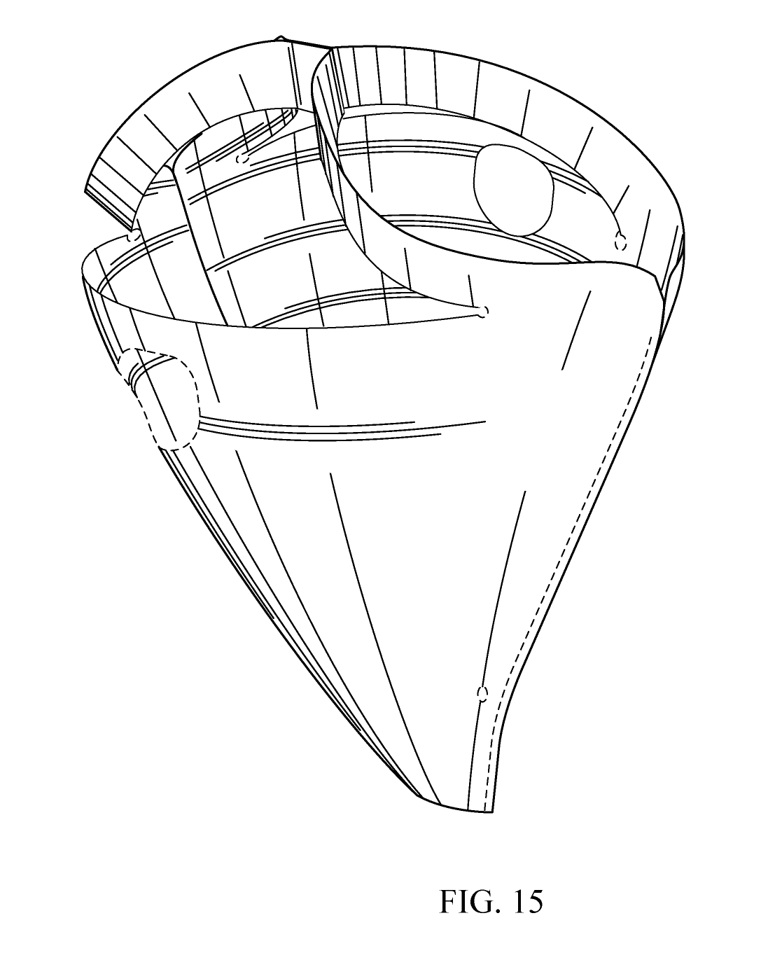

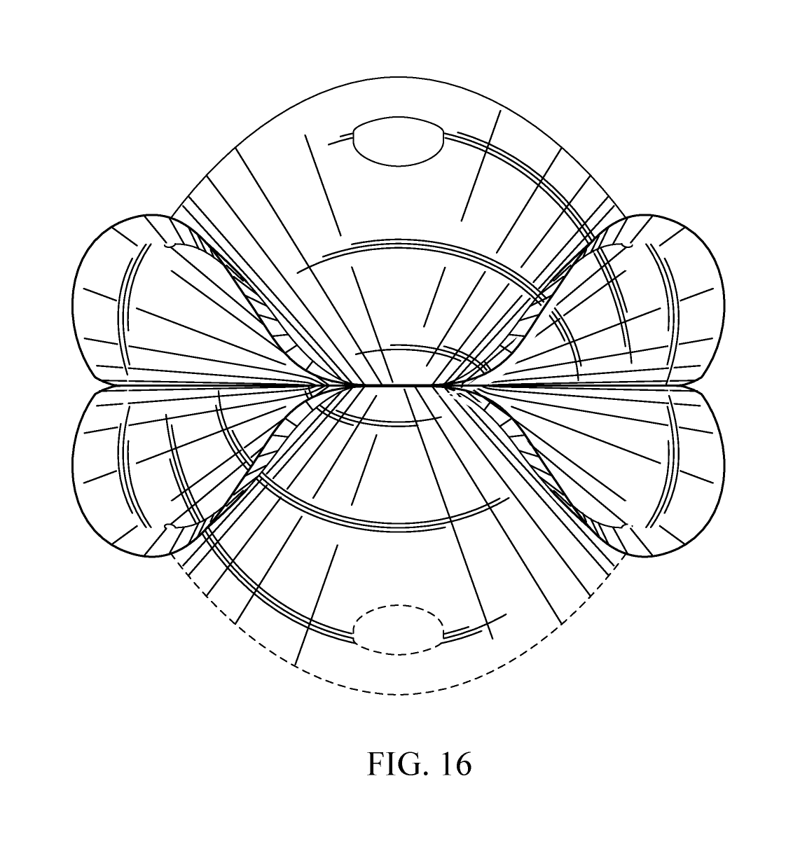

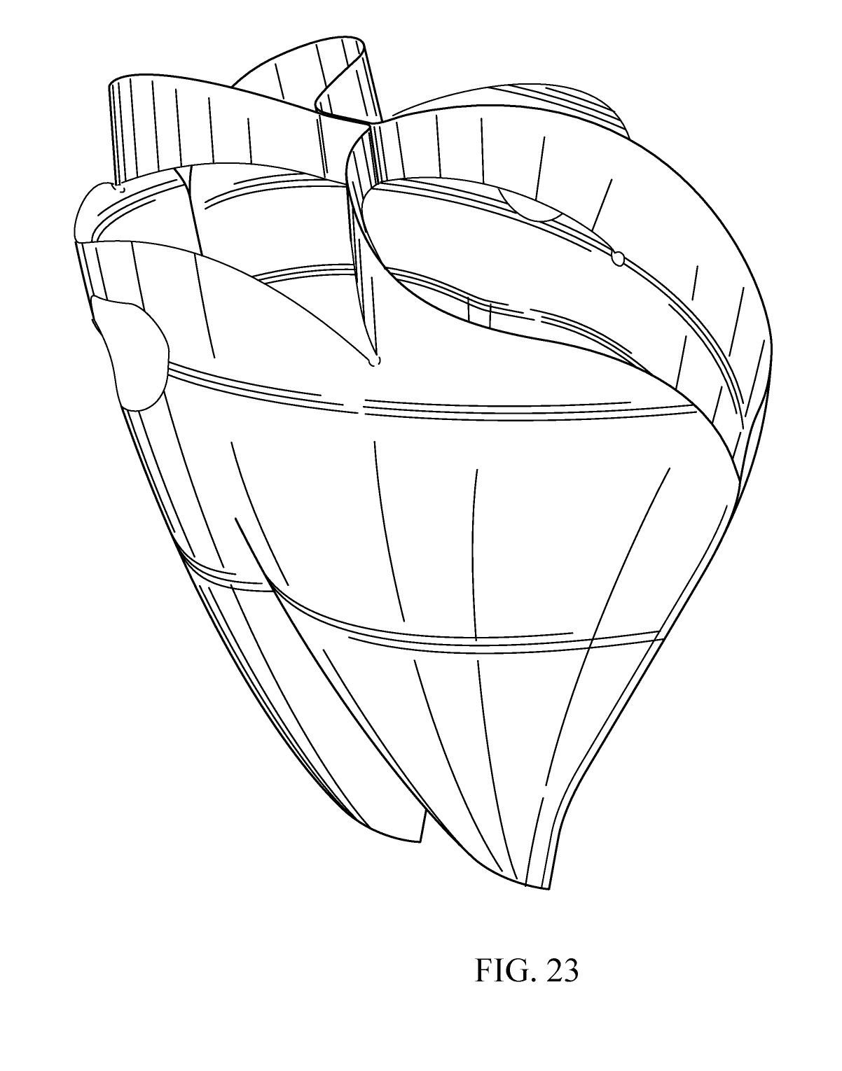

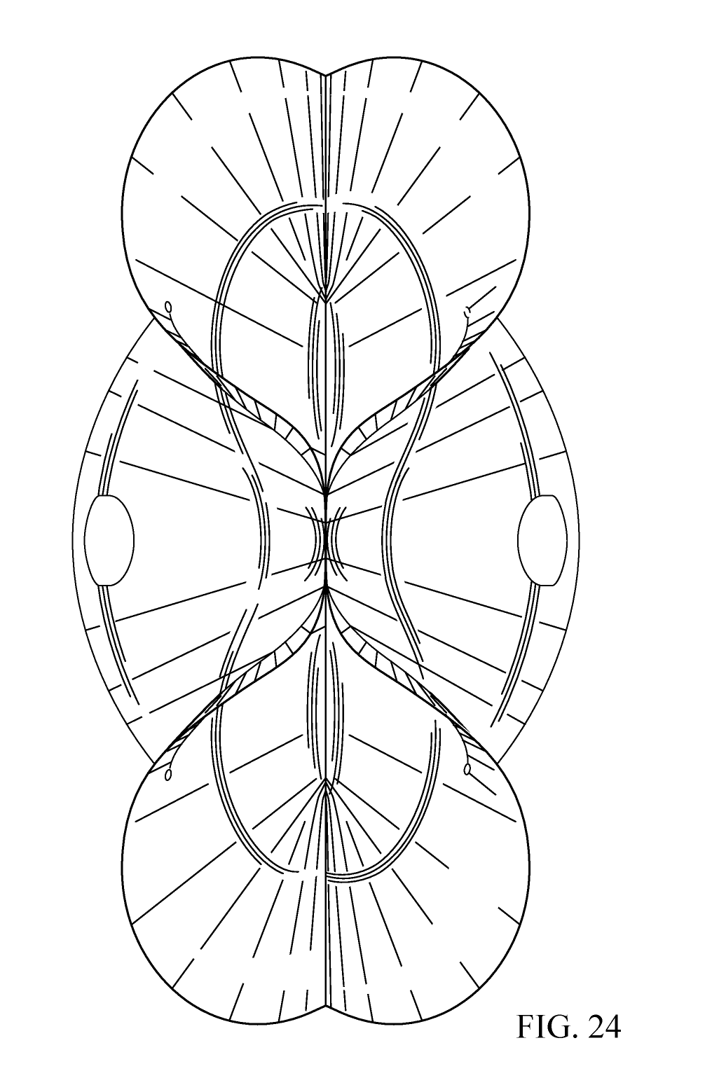

Slits 20 and 22 define an opening in upper portion of first panel and second panel to form handle portion 30 of first panel 4 and handle portion 32 of second panel 6 extending from upper edge of slits 20 and 22 to upper edge of first panel 4 and second panel 6. When pouch is filled, handle portions 30 and 32 arch over head of produce and allows for carrying filled pouch. All or a portion of handle portions 30 and 32 can be reversibly joined as illustrated in exemplary embodiments shown in FIGS. 7, 8, 15, 16, 23 and 24. Handle portions 30 and 32 can be reversibly joined using fastening methods known to those skilled in the art such as, for example, using adhesives (e.g., glues, adhesive tapes), zippers, staples, snaps, hook and loop, and the like. In other embodiments, a fastener is not included.

Slits cut into first panel and second panel can be of any desired shape. Particularly suitable shape of the cut making the slit is curved (for example, parallel to convex shape of upper edges of first panel and second panel) as illustrated in FIGS. 1 and 2. Straight cuts and concave cuts, although less desirable, can be suitable. Cuts forming the slits in first panel and second panel can optionally extend between perforations 24 in first panel and second panel. Perforations 24 at each end of slit can reduce or prevent tearing of the material used to form the first panel and the second panel. Each end of the cuts forming the slits in first panel and second panel can optionally be reinforced by bonding a material at each end of the slits to reduce or prevent tearing of the material used to form the first panel and the second panel.

Slits can be cut at any desired distance below upper edge of first panel and second panel. In some embodiments, the slits are cut about 1 inch below upper edge of first panel and second panel. It is desirable for slit cut in first panel and slit cut in second panel to be equidistant from upper edges.

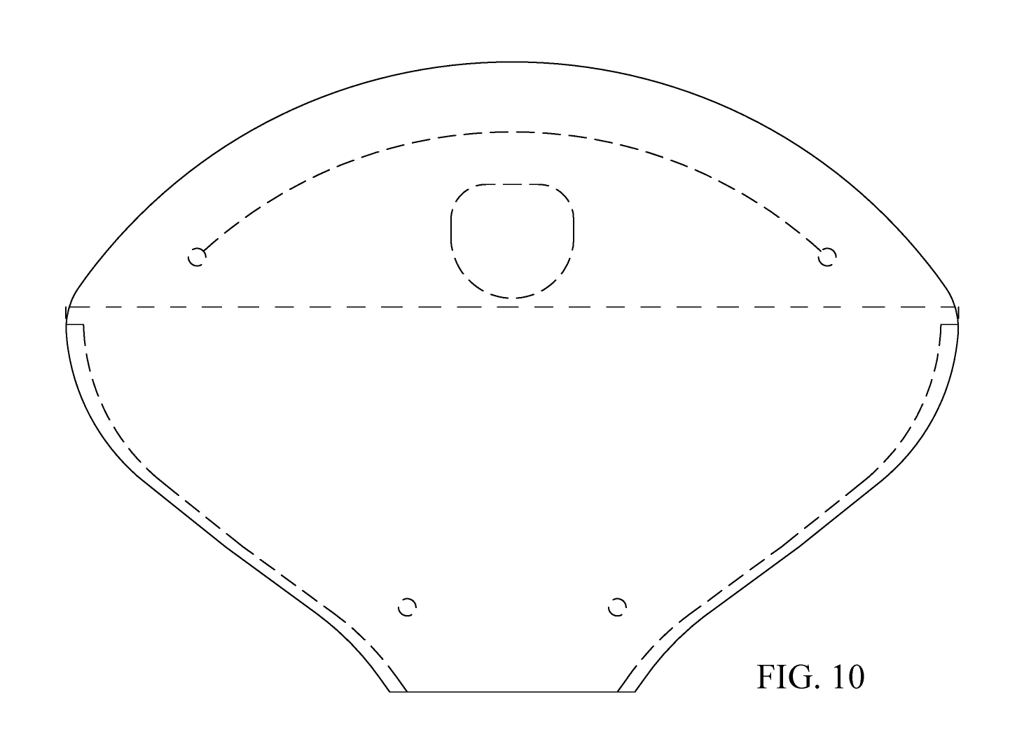

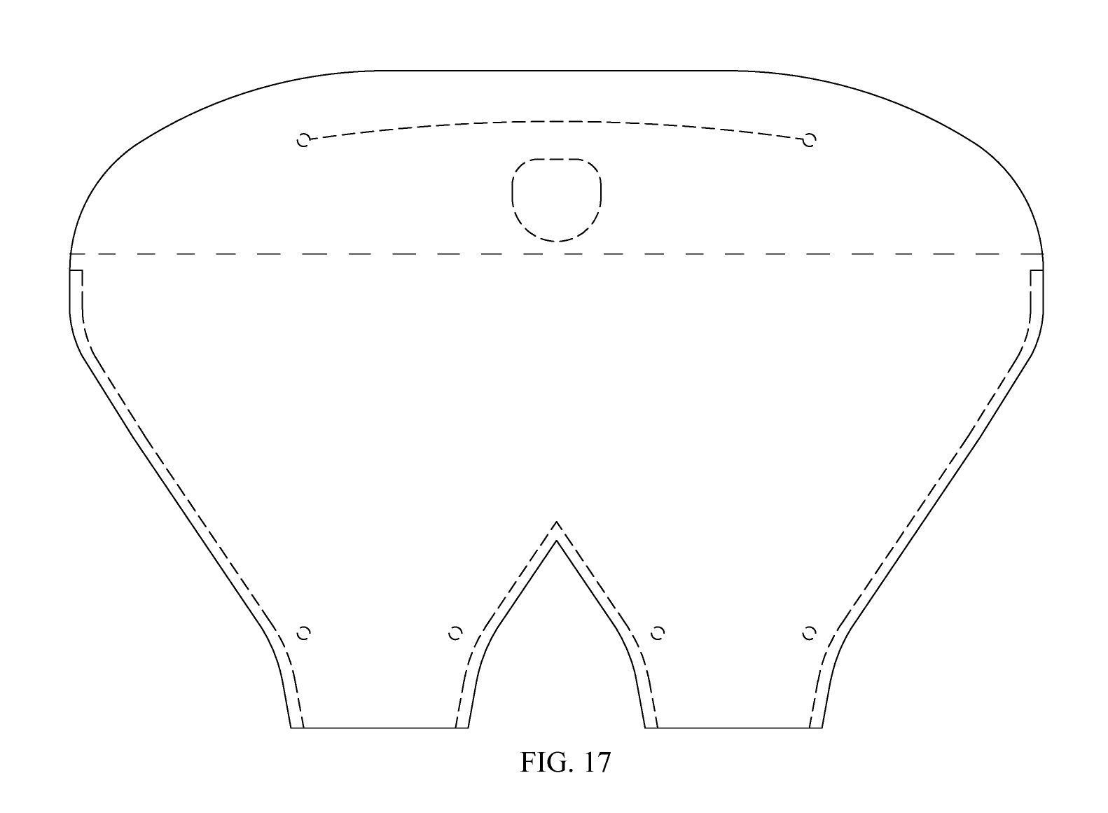

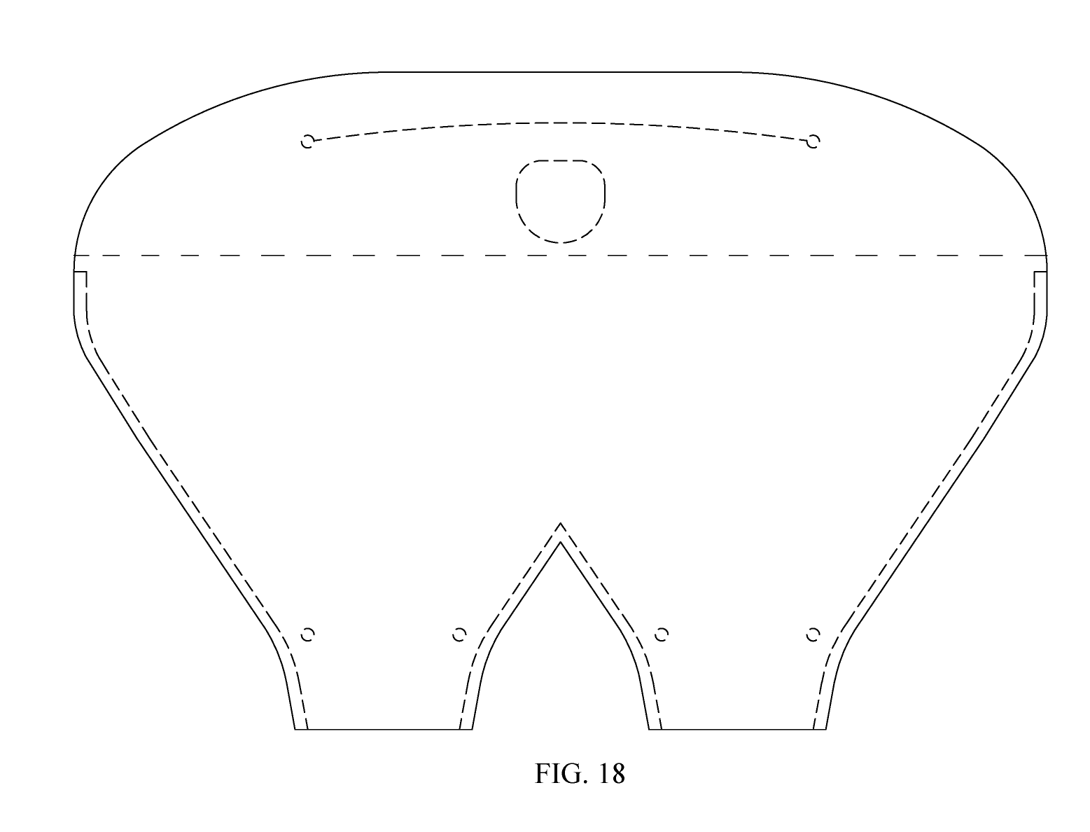

As illustrated in FIGS. 1, 2, 9, 10, 17 and 18, the bottom portion of panels forming the structure of the pouches to hold the root structure of the produce is more narrow than the portions of the front and rear panels for containing the leafy structure of the produce heads. Particularly suitable dimensions of the bottom portion of the pouch for housing the root structure can range from about 2.5 inches in diameter to about 5 inches in diameter, including from about 3.0 inches to about 4 inches in diameter. In embodiments comprising a plurality of bottom portions for housing a plurality of heads of produce, each bottom portion of the plurality can range from about 2.5 inches in diameter to about 5 inches in diameter, including from about 3.0 inches to about 4 inches in diameter. From the bottom edge of the pouch to the upper edge of the pouch, the dimensions desirably fit a head of produce. Generally, the dimensions of the pouch from the bottom edge of the pouch to the upper edge of the pouch can range from about 7 inches to about 15 inches, including from about 8 inches to about 14 inches. In embodiments for holding a single head of produce including produce having an elongated head structure and a ball-like structure, the dimensions as measured at the widest portion of the panel can range from about 4 inches in diameter to about 15 inches in diameter. In embodiments for holding a plurality of heads of produce, in particular an embodiment for holding two heads of produce as illustrated in FIGS. 17 and 18, the dimensions as measured at the widest portion of the panel can range from about 15 inches in diameter to about 30 inches in diameter.

Suitable methods for joining left side edges, right side edges and lower edges of first and second panels include adhesives and heat sealing.

At least one of first panel and second panel can optionally include one or more perforations 34 to ventilate the produce when introduced to the produce pouch.

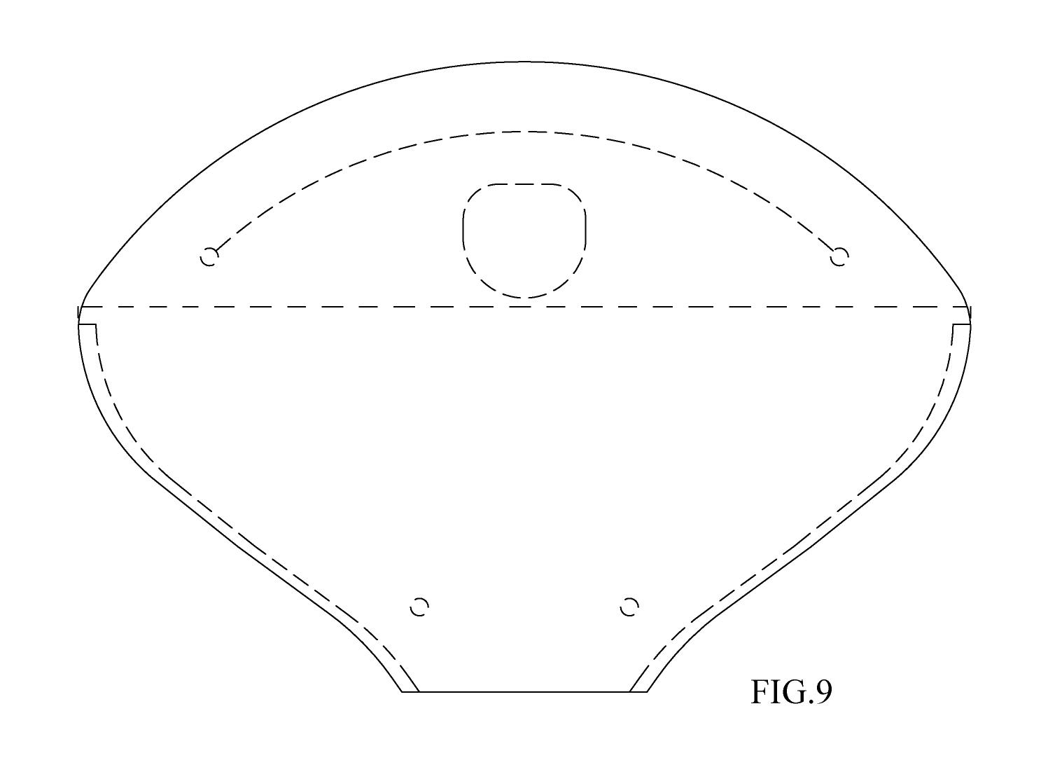

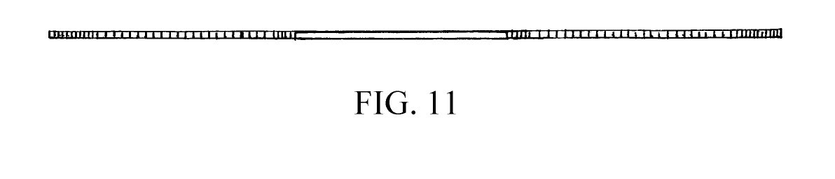

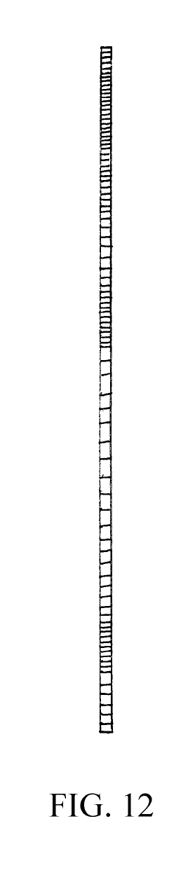

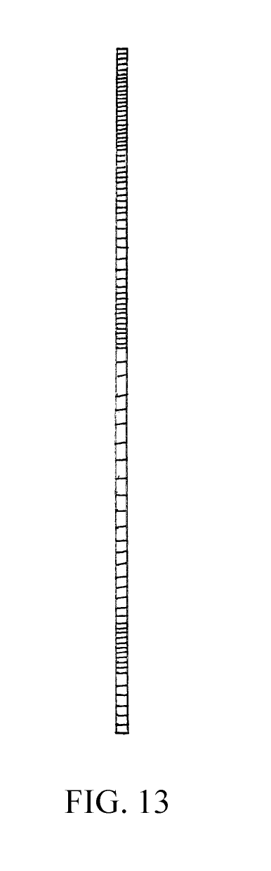

As illustrated in FIGS. 1-3, the bottom portion of the produce pouch is configured to selectively receive a root structure of the produce when introduced to the produce pouch. Optionally, the root structure of the produce can be placed in a container that is inserted into the bottom portion of the produce pouch. The curvature of left edge 8 and right edge 10 is designed to fit the structure of the head of produce. In FIGS. 1-6, the curvature of the produce pouch is designed to fit the elongated structure of a head of Romaine lettuce, for example. In FIGS. 9-13, the curvature of the produce pouch is designed to fit the ball-like structure of a head of iceberg lettuce or cabbage, for example.

In another aspect, the present disclosure is directed to produce pouch comprising a first panel and a second panel joined along a bottom portion and two side edges to form the produce pouch; wherein an upper edge of the produce pouch forms a convex shape; and wherein the bottom portion of the produce pouch is configured to selectively receive a plurality of root structures of the produce when introduced to the produce pouch; wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration; wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration. In this aspect, each root bulb of each head of produce is positioned in each bottom portions of the pouch.

FIG. 17 depicts a front view and FIG. 18 depicts a rear view of an exemplary embodiment of a pouch comprising two bottom portions for holding two heads of produce.

A person skilled in the art will appreciate that when the pouch is filled with a head of produce, the inner surface of the first panel and the inner surface of the second panel define a cavity between the inner surface of the first panel and the inner surface of the second panel in the open configuration to surround the head of produce. In addition, the inner surface of the first panel and the inner surface of the second panel at the bottom portions of the pouch form a base-like structure into which the root bulb of the produce head will fit. In some embodiments, the bottom portion of the pouch can fit a container into which the root bulb can be inserted. Thus, in this exemplary embodiment, the head of produce with root bulb inserted into a container can be placed in the pouch such that the container fits the bottom portion of the pouch. The optional root bulb container can provide protection for the root bulb structure of the head of produce.

Any suitable material known to those skilled in the art can be used to prepare pouches of the present disclosure. Suitable materials include plastic materials such as thermoplastic films. Among the film forming materials which can be used in making the pouches of the present disclosure are thermoplastic synthetic polymers of polyolefins such as low density polyethylene, linear low density polyethylene, polypropylene, high density polyethylene, random copolymers of ethylene and propylene and combinations of these polymers; polyesters; polyamides; polyvinyl polymers such as polyvinylalcohol, polyvinylchloride, polyvinylacetate, polyvinylidenechloride and copolymers of the monomers of these polymers. Particularly suitable materials include transparent materials that allow for viewing of the contents contained in the pouches of the present disclosure.

Materials can be formed into films by extrusion, coextrusion, casting, blowing or other film-forming methods known to those skilled in the art. The thickness of the films can be any desired thickness. Typical thickness can range from about 0.3 to about 20 mil. Films can be used containing one or more layers of material.

Pouches can be reinforced by forming layers of material over a portion of at least one of the first panel and the second panel. The same or different materials can be used for forming layers. Particularly suitable portions of pouches for reinforcement include the upper portions of panels comprising the cuts to form slits that will form the handle portions and bear most of the weight of the produce when introduced in the pouch. Additionally or alternatively, pouches can be reinforced by applying labels to all or a portion of at least one of the first panel and the second panel. As described herein, extra film layers can be heat-welded to first panel and second panels.

Pouches can be manufactured by any suitable technique but are particularly suited for manufacture using high speed or automated bag-forming equipment. Sealing materials to form the pouches and equipment are well known to those of ordinary skill in the art and the selection of such is dependent on the exercise of sound engineering judgment, to be exercised with knowledge of the present disclosure combined with knowledge of the properties of the materials employed. Generally, pouches are made by cutting material to desired dimensions and shape, folding and forming the material, heat-sealing to form a longitudinal seam, heat-sealing or stitching an end, applying a fastener if used, and, if used, applying a print band or label. Labels can be heat sealed to the material.

Pouches of the present disclosure can further include labels. Labels placed on upper portions of first panel and/or second panel can provide additional strength to pouch to prevent or reduce stretching and tearing of the primary pouch material. Labels placed on upper portions of first panel and/or second panel can include slits and cut-outs similar to or matching slits and cut-outs of first panel and/or second panel to form handle portions, to allow ventilation, and to allow hanging from bag dispensers and bag filling machines.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiments contemplated for carrying out this invention, but that the invention will include all embodiments falling within the scope of the appended claims.

What is claimed is:

1. A produce pouch comprising
a first panel and a second panel joined along a bottom portion and two side edges to form the produce pouch;
wherein an upper edge of the produce pouch forms a convex shape;
and wherein the bottom portion of the produce pouch is configured to selectively receive a root structure of the produce when introduced to the produce pouch;
wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration;
wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration.

2. The produce bag of claim 1 wherein the handle comprises a fastener configured to reversibly couple the handle.

3. The produce bag of claim 2 wherein the fastener is chosen from an adhesive, a snap, a zipper, a staple, and combinations thereof.

4. The produce bag of claim 1 wherein at least one of the first panel and the second panel comprises a perforation.

5. A produce pouch comprising
a first panel and a second panel joined along a bottom portion and two side edges to form the produce pouch;
wherein an upper edge of the produce pouch forms a convex shape;
and wherein the bottom portion of the produce pouch is configured to selectively receive a plurality of root structures of the produce when introduced to the produce pouch
wherein a top portion of the first panel comprises a curved slit cut therein and a top portion of the second panel comprises a curved slit cut therein, wherein upper edge of the curved slit of the first panel to upper edge of the first panel forms a first handle portion and upper edge of the curved slit of the second panel to upper edge of the second panel forms a second handle portion, wherein the first handle portion and second handle portion are movable between a closed configuration and an open configuration;
wherein a lower edge of the slit of the first panel is separable from a lower edge of the slit of the second panel to define a mouth configured to selectively receive the produce and wherein the first panel and the second panel are movable between a closed configuration and an open configuration, wherein the inner surface of the first panel and the inner surface of the second panel define a cavity between the inner surface of the first panel and the inner surface of the second panel in the open configuration.

6. The produce bag of claim 5 wherein the handle comprises a fastener.

7. The produce bag of claim 6 wherein the fastener is chosen from an adhesive, a snap, a zipper, a staple, and combinations thereof.

8. The produce bag of claim 5 wherein at least one of the first panel and the second panel comprises a perforation.
